(19) United States
(12) Patent Application Publication
(10) Pub. No.: US 2017/0062149 A1
(43) Pub. Date: Mar. 2, 2017

(54) Switch and Manufacturing Method of Switch

(71) Applicants: Atsushi Kodama, Tokyo (JP); Hidetake Kikuchi, Tokyo (JP)

(72) Inventors: Atsushi Kodama, Tokyo (JP); Hidetake Kikuchi, Tokyo (JP)

(73) Assignee: Mitsumi Electric Co., Ltd., Tokyo (JP)

(21) Appl. No.: 15/250,089

(22) Filed: Aug. 29, 2016

(30) Foreign Application Priority Data
Aug. 31, 2015 (JP) 2015-170846

(51) Int. Cl. H01H 13/06; H01H 11/00

(52) U.S. Cl. CPC H01H 13/06; H01H 11/00

(57) ABSTRACT

A switch is provided with a case, a plurality of fixed conductive member, a movable conductive member, and a waterproof part. The case is formed of a first resin. The waterproof part is formed of a second resin whose adhesion to the plurality of fixed conductive members is higher than an adhesion of the first resin to the plurality of fixed conductive members. Each of the plurality of fixed conductive members includes a first portion arranged inside a recess of the case, a second portion exposed to an outside of the case, and a third portion positioned between the first portion and the second portion. The waterproof part surrounds the third portion of the each of the plurality of fixed conductive members.

### CROSS-REFERENCES TO RELATED APPLICATION

This application is based on and claims priority from Japanese Patent Application No. 2015-170846 filed on Aug. 31, 2015, the entire contents of which are incorporated herein by reference.

### BACKGROUND

1. Field of the Invention

The present invention relates to a switch mounted in an electronic device etc. Also, the invention relates to a manufacturing method of a switch mounted in an electronic device etc.

2. Description of Related Art

JP-A-2003-234040 discloses a switch including a resin-made case, plural fixed conductive members, and a movable conductive member. The plural fixed conductive members are supported by the case. The movable conductive member is displaced according to switch-operation of a user, and changes a state of conduction between the plural fixed conductive members.

### SUMMARY

In accordance with one or more embodiments, a switch is provided with a case, a plurality of fixed conductive member, a movable conductive member, a cover, and a waterproof part. The case is formed of a first resin and has a recess. The plurality of fixed conductive members is supported by the case. The movable conductive member is capable of changing a state of electrical connection between the plurality of fixed conductive members. The recess of the case is sealed with the cover. The waterproof part is formed of a second resin whose adhesion to the plurality of fixed conductive members is higher than an adhesion of the first resin to the plurality of fixed conductive members. Each of the plurality of fixed conductive members includes a first portion arranged inside the recess, a second portion exposed to an outside of the case, and a third portion positioned between the first portion and the second portion. The waterproof part surrounds the third portion of the each of the plurality of fixed conductive members.

In accordance with one or more embodiments, a switch is manufactured by: supporting a plurality of fixed conductive members by a case made of a first resin so that a first portion of each of the plurality of fixed conductive members is arranged inside a recess of the case, a second portion of the each of the plurality of fixed conductive member is exposed to an outside of the case, and a third portion of the each of the plurality of fixed conductive member is exposed to an inside of a hole of the case; arranging a movable conductive member in the recess of the case, wherein the movable conductive member is configured to be capable of changing a state of electrical connection between the plural fixed conductive members; sealing the recess with a cover; filling the hole of the case with a second resin whose adhesion to the plurality of fixed conductive members is higher than an adhesion of the first resin to the plurality of fixed conductive members; and curing the second resin and forming a waterproof part that surrounds the third portion of the each of the plurality of fixed conductive members.

### BRIEF DESCRIPTION OF THE DRAWINGS

FIG. 1 is an exploded perspective view showing a push switch according to one embodiment.

FIGS. 2A to 2D are four-sided views showing appearance of the push switch of FIG. 1.

FIGS. 3A and 3B are views describing a method for manufacturing a push switch.

FIGS. 4A to 4D are views describing the method for manufacturing the push switch.

### DETAILED DESCRIPTION

Exemplary embodiments are described in detail with reference to the accompanying drawings. In each of the drawings used in the following description, a scale is suitably adjusted for well recognition of each member. The terms “front and back”, “left and right” and “upward and downward” are used for convenience of description, and do not intend to limit postures or directions in an actual use state of each member.

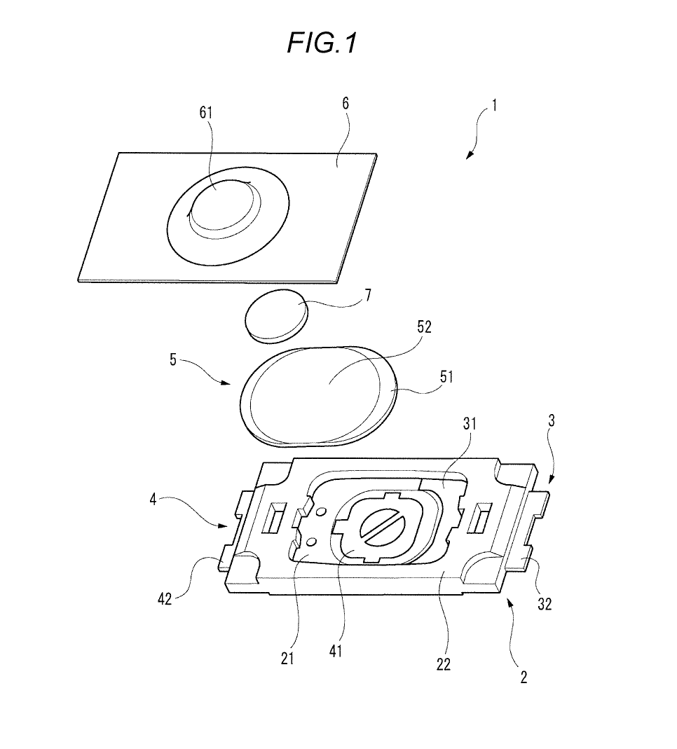

FIG. 1 is an exploded perspective view showing a configuration of a push switch 1 (one example of a switch) according to one embodiment. The push switch 1 includes a case 2, a first fixed conductive member 3, a second fixed conductive member 4, a movable conductive member 5, a cover 6, and a pressing member 7.

The case 2 is formed of an insulating resin. The resin for forming the case 2 is hereinafter called a first resin. An example of the first resin includes a liquid crystal polymer resin, a nylon resin, etc. The case 2 has a recess 21 opened upwardly.

The first fixed conductive member 3 and the second fixed conductive member 4 are formed of conductive materials. The first fixed conductive member 3 and the second fixed conductive member 4 are supported by the case 2.

The first fixed conductive member 3 has a first portion 31. The first portion 31 of the first fixed conductive member 3 is arranged inside the recess 21 of the case 2. The second fixed conductive member 4 has a first portion 41. The first portion 41 of the second fixed conductive member 4 is arranged inside the recess 21 of the case 2. The first portion 31 of the first fixed conductive member 3 is separated from the first portion 41 of the second fixed conductive member 4 and is electrically insulated from the first portion 41 of the second fixed conductive member 4.

The first fixed conductive member 3 has a second portion 32. The second portion 32 of the first fixed conductive member 3 is exposed to the outside of the case 2. The second portion 32 of the first fixed conductive member 3 is used as a connecting terminal to an external circuit. The second fixed conductive member 4 has a second portion 42. The second portion 42 of the second fixed conductive member 4 is exposed to the outside of the case 2. The second portion 42 of the second fixed conductive member 4 is used as a connecting terminal to an external circuit.

The movable conductive member 5 is formed of a conductive material. The movable conductive member 5 is a dome-shaped member capable of being elastically deformed. The movable conductive member 5 has an outer edge part 51 and a central part 52. The movable conductive member 5 is stored in the recess 21. At this time, the outer edge part 51 makes contact with the first fixed conductive member 3, and the central part 52 is opposed to the second fixed conductive member 4 at a distance. That is, the movable conductive member 5 is set in an upwardly protruding state at the normal time.

The cover 6 is attached to an upper surface 22 of the case 2 so as to seal the recess 21. The cover 6 has a protrusion 61. The protrusion 61 has an upwardly protruding shape. The protrusion 61 is arranged as opposed to the movable conductive member 5. The pressing member 7 is attached to an inner surface of the protrusion 61. Hence, the pressing member 7 is arranged between the inner surface (lower surface) of the protrusion 61 and the movable conductive member 5.

A user can depress the protrusion 61 of the cover 6 directly or indirectly. When the protrusion 61 is depressed, the pressing member 7 depresses the central part 52 of the movable conductive member 5 arranged under the protrusion 61. When a load applied to the movable conductive member 5 exceeds a predetermined value, the central part 52 is reversed with a click feeling and is changed into a downwardly protruding state.

Accordingly, the central part 52 of the movable conductive member 5 makes contact with the first portion 41 of the second fixed conductive member 4, and electrical connection between the first portion 41 of the second fixed conductive member 4 and the first portion 31 of the first fixed conductive member 3 is made through the movable conductive member 5. That is, the movable conductive member 5 changes a state of electrical connection between the first fixed conductive member 3 and the second fixed conductive member.

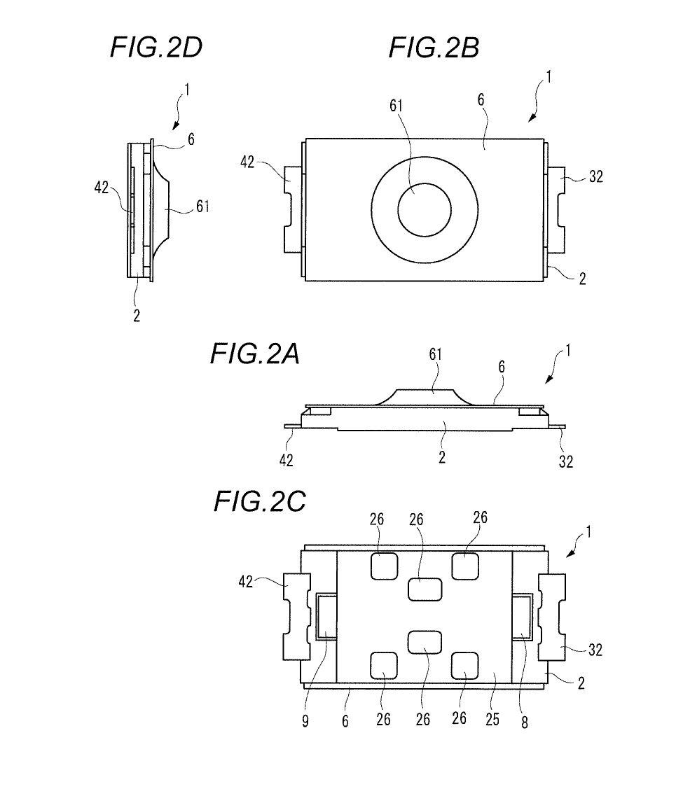

FIGS. 2A to 2D are four-sided views showing appearance of the push switch 1. FIG. 2A is a front view. FIG. 2B is a top view. FIG. 2C is a bottom view. FIG. 2D is a left side view. Since a shape viewed from the right side is symmetrical to that shown in the left side view, illustration is omitted. Since a shape viewed from the rear side is symmetrical to that shown in the front view, illustration is omitted.

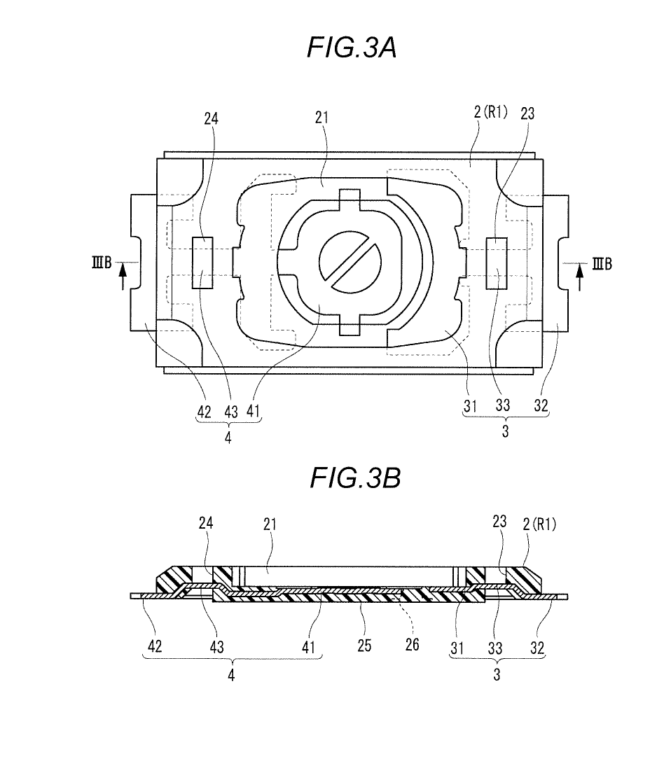

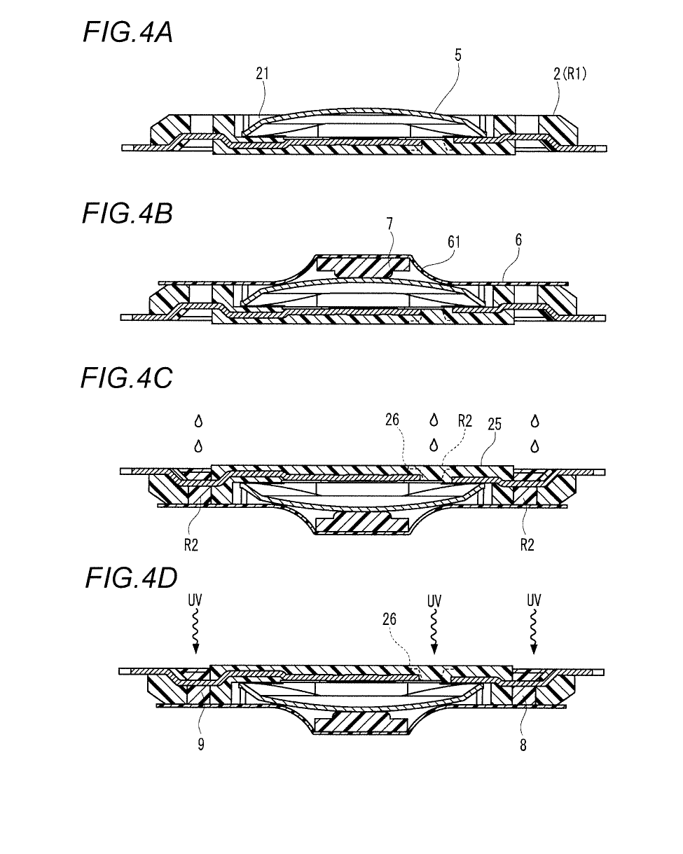

A method for manufacturing the push switch 1 having such a configuration will be described with reference to FIGS. 3A and 3B and FIGS. 4A to 4D.

As shown in FIG. 3A, the first fixed conductive member 3 has a third portion 33. The third portion 33 of the first fixed conductive member 3 is positioned between the first portion 31 and the second portion 32 of the first fixed conductive member 3. The second fixed conductive member 4 has a third portion 43. The third portion 43 of the second fixed conductive member 4 is positioned between the first portion 41 and the second portion 42 of the second fixed conductive member 4.

FIG. 3B is a view in the case of seeing a cross section along line IIIB-IIIB in FIG. 3A from an arrow direction. FIGS. 4A to 4D are respectively cross-sectional views corresponding to FIG. 3B, and show each of the steps in the method for manufacturing the push switch 1 according to an embodiment.

First, the first fixed conductive member 3 and the second fixed conductive member 4 are supported by the case 2 made of a first resin RI and having the recess 21, a first hole 23 and a second hole 24. At this time, the first portion 31 of the first fixed conductive member 3 and the first portion 41 of the second fixed conductive member 4 are arranged inside the recess 21, and the second portion 32 of the first fixed conductive member 3 and the second portion 42 of the second fixed conductive member 4 are exposed to the outside of the case 2. Also, the third portion 33 of the first fixed conductive member 3 is exposed to the inside of the first hole 23, and the third portion 43 of the second fixed conductive member 4 is exposed to the inside of the second hole 24. Such a state is obtained by, for example, insert molding.

At this point in time, plural holes 26 are opened in a lower surface 25 of the case 2 as a mark in the case of pulling a pin for holding the first fixed conductive member 3 and the second fixed conductive member 4 at the time of the insert molding. Each of the holes 26 is pierced in the case 2 so as to be opposed and communicated to any of the first portion 31 of the first fixed conductive member 3 and the first portion 41 of the second fixed conductive member 4. One of the holes 26 is shown by a broken line in FIG. 3B.

As shown in FIG. 4A, the movable conductive member 5 is arranged inside the recess 21 of the case 2. As shown in FIG. 4B, the recess 21 is sealed with the cover 6 to which the pressing member 7 is attached.

As shown in FIG. 4C, the first hole 23 and the second hole 24 are filled with a second liquid resin R2 from the side of the lower surface 25 of the case 2. Adhesion of the second resin R2 to the first fixed conductive member 3 and the second fixed conductive member 4 is higher than that of the first resin R1.

Each of the plural holes 26 opened in the lower surface 25 of the case 2 is filled with the second liquid resin R2.

In the embodiment, the second resin R2 is an ultraviolet curable resin. Consequently, as shown in FIG. 4D, by irradiation with ultraviolet rays UV, the second resin R2 is cured to form a first waterproof part 8 for surrounding the third portion 33 of the first fixed conductive member 3. Similarly, a second waterproof part 9 for surrounding the third portion 43 of the second fixed conductive member 4 is formed.

The second resin R2 injected into each of the plural holes 26 opened in the lower surface 25 of the case is cured by irradiation with the ultraviolet rays UV. Accordingly, plural waterproof parts 26 for sealing the first portion 31 of the first fixed conductive member 3 and the first portion 41 of the second fixed conductive member 4 from the side of the lower surface 25 of the case 2 are formed.

As a result, the first waterproof part 8, the second waterproof part 9 and the plural waterproof parts 26 can be identified when viewed from the side of the lower surface 25 of the case 2 as shown in FIG. 2C.

According to such a configuration, even when water enters a small gap formed between the case 2 and the second portion 32 of the first fixed conductive member 3, the water can be prevented from reaching the first portion 31 of the first fixed conductive member 3 arranged inside the recess 21 of the case 2. This is because the first waterproof part 8 makes close contact with the third portion 33 of the first fixed conductive member 3 positioned between the first portion 31 and the second portion 32 and passage of the water is prevented.

Similarly, even when water enters a small gap formed between the case 2 and the second portion 42 of the second fixed conductive member 4, the water can be prevented from reaching the first portion 41 of the second fixed conductive member 4 arranged inside the recess 21 of the case 2. This is because the second waterproof part 9 makes close contact with the third portion 43 of the second fixed conductive member 4 positioned between the first portion 41 and the second portion 42 and passage of the water is prevented.

Accordingly, the first portion 31 of the first fixed conductive member 3, the first portion 41 of the second fixed conductive member 4 and the movable conductive member 5 arranged inside the recess 21 of the case 2 can be protected from the water enterable through the second portion 32 of the first fixed conductive member 3 and the second portion 42 of the second fixed conductive member 4 used as the connecting terminal to the external circuit. Consequently, waterproofness of the push switch 1 mounted in an electronic device can be improved. Accordingly, for example, after the push switch 1 is mounted in a substrate, a waterproof coating applied to the second portion 32 of the first fixed conductive member 3 and the second portion 42 of the second fixed conductive member 4 can be omitted.

Further, the plural waterproof parts 26 prevent the water from entering the inside of the recess 21 from the side of the lower surface 25 of the case 2. Consequently, the waterproofness of the push switch 1 mounted in the electronic device can be improved more.

In the embodiment, the ultraviolet curable resin is used as the second resin R2 as described above. Hence, by irradiation with ultraviolet rays, the second resin R2 is cured to form the first waterproof part 8 and the second waterproof part 9.

Even when the thickness of the second resin R2 to be cured is relatively thick, the irradiated ultraviolet rays are easily transmitted to the inside of a resin layer, with the result that curing is completed in a short time. Hence, time necessary for a step of forming the first waterproof part 8 and the second waterproof part 9 can be shortened. On the other hand, since the second resin R2 is not cured unless the second resin R2 is irradiated with the ultraviolet rays, restrictions on a filling step are small. Consequently, the waterproofness of the push switch 1 mounted in the electronic device can be improved efficiently.

In the embodiment, the first hole 23 and the second hole 24 filled with the second resin R2 are through holes vertically pierced in the case 2. As shown in FIG. 4(C), with one end of each of the first hole 23 and the second hole 24 covered with the cover 6, each of the holes 23 and 24 is filled with the second resin R2 from the other end of each of the holes 23 and 24. Consequently, the first waterproof part 8 and the second waterproof part 9 formed by curing the second resin R2 abut on the cover 6.

According to such a configuration, in the filling step of the second resin R2, a part of the cover 6 can be used as a lid for preventing the second resin R2 from flowing out of the first hole 23 and the second hole 24. Accordingly, the first hole 23 and the second hole 24 can surely be filled with the second liquid resin R2 without requiring additional metal mold equipment etc. Consequently, the waterproofness of the push switch 1 mounted in the electronic device can be improved efficiently.

The embodiments and modification thereof described above are only illustration for facilitating understanding of the invention. The configuration according to the embodiments described above may properly be changed or improved. Also, it is apparent that equivalents are included in the technical scope of the invention.

In the above description, the push switch is illustrated as the switch according to the invention. However, as long as the switch includes the plural fixed conductive members supported by the case and the movable conductive member for changing a state of electrical connection between the plural fixed conductive members, the invention can also be applied to other kinds of switch such as a slide switch.

In the embodiment described above, the ultraviolet curable resin is used as the second resin R2. However, a thermosetting resin or an underfill resin may be used as the second resin R2.

In the embodiment described above, one end of each of the first hole 23 and the second hole 24 is covered with a part of the cover 6 in the filling step of the second resin R2. However, with one end of each of the first hole 23 and the second hole 24 covered with proper equipment, each of the holes 23 and 24 may be filled with the second resin R2. In this case, the size of the cover 6 can be set in the minimum size to cover the recess 21 of the case 2.

In the embodiment described above, the first hole 23 and the second hole 24 filled with the second resin R2 are the through holes pierced in the case 2. However, as long as the first waterproof part 8 and the second waterproof part 9 formed by curing the second resin R2 can surround the third portion 33 of the first fixed conductive member 3 and the third portion 43 of the second fixed conductive member 4, respectively, the first hole 23 and the second hole 24 with bottomed shapes can be adopted. In this case, the size of the cover 6 can be set in the minimum size to cover the recess 21 of the case 2.

According to the exemplary embodiments, a switch having a high waterproofness is provided.

In accordance with the exemplary embodiments, a switch is provided with a case, a plurality of fixed conductive member, a movable conductive member, a cover, and a waterproof part. The case is formed of a first resin and has a recess. The plurality of fixed conductive members is supported by the case. The movable conductive member is capable of changing a state of electrical connection between the plurality of fixed conductive members. The recess of the case is sealed with the cover. The waterproof part is formed of a second resin whose adhesion to the plurality of fixed conductive members is higher than an adhesion of the first resin to the plurality of fixed conductive members. Each of the plurality of fixed conductive members includes a first portion arranged inside the recess, a second portion exposed to an outside of the case, and a third portion positioned between the first portion and the second portion. The waterproof part surrounds the third portion of the each of the plurality of fixed conductive members.

In accordance with exemplary embodiments, a switch is manufactured by: supporting a plurality of fixed conductive members by a case made of a first resin so that a first portion of each of the plurality of fixed conductive members is arranged inside a recess of the case, a second portion of the each of the plurality of fixed conductive member is exposed to an outside of the case, and a third portion of the each of the plurality of fixed conductive member is exposed to an inside of a hole of the case; arranging a movable conductive member in the recess of the case, wherein the movable conductive member is configured to be capable of changing a state of electrical connection between the plural fixed conductive members; sealing the recess with a cover; filling the hole of the case with a second resin whose adhesion to the plurality of fixed conductive members is higher than an adhesion of the first resin to the plurality of fixed conductive members; and curing the second resin and forming a waterproof part that surrounds the third portion of the each of the plurality of fixed conductive members.

According to such structure and manufacturing method, even when water enters a small gap formed between the case and the second portion of each of the fixed conductive members, the water can be prevented from reaching the first portion of each of the fixed conductive members arranged inside the recess of the case. This is because the waterproof part makes close contact with the third portion of each of the fixed conductive members positioned between the first portion and the second portion and passage of the water is prevented.

Accordingly, the first portion of each of the fixed conductive members and the movable conductive member arranged inside the recess of the case can be protected from the water enterable through the second portion of each of the fixed conductive members used as a connecting terminal to an external circuit. Consequently, waterproofness of the switch mounted in an electronic device can be improved. Accordingly, for example, after the switch is mounted in a substrate, a waterproof coating applied to the second portion of each of the fixed conductive members can be omitted.

In the above structure, the second resin may be an ultraviolet curable resin.

In the above manufacturing method, the second resin may be cured by irradiation with ultraviolet rays.

Even when the thickness of the second resin to be cured is relatively thick, the irradiated ultraviolet rays are easily transmitted to the inside of a resin layer, with the result that curing is completed in a short time. Hence, time necessary for a step of forming the waterproof part can be shortened. On the other hand, since the second resin is not cured unless the second resin is irradiated with the ultraviolet rays, restrictions on a filling step are small. Consequently, the waterproofness of the switch mounted in the electronic device can be improved efficiently.

In the above structure, the cover may abut on the waterproof part.

In the above manufacturing method, the hole may be a through hole penetrating through the case, and with one end of the hole covered with the cover, the hole may be filled with the second resin from the other end of the hole.

According to such structure and manufacturing method, in the filling step of the second resin, a part of the cover can be used as a lid for preventing the second resin from flowing out of the hole. Accordingly, the hole can surely be filled with the second liquid resin without requiring additional metal mold equipment etc. Consequently, the waterproofness of the switch mounted in the electronic device can be improved efficiently.

According to the structure and manufacturing method of the exemplary embodiments, the waterproofness of the switch mounted in the electronic device is improved.

### DESCRIPTION OF REFERENCE NUMERALS AND SIGNS

1: PUSH SWITCH
2: CASE
21: RECESS
23: FIRST HOLE
24: SECOND HOLE
3: FIRST FIXED CONDUCTIVE MEMBER
31: FIRST PORTION
32: SECOND PORTION
33: THIRD PORTION
4: SECOND FIXED CONDUCTIVE MEMBER
41: FIRST PORTION
42: SECOND PORTION
43: THIRD PORTION
5: MOVABLE CONDUCTIVE MEMBER
6: COVER
8: FIRST WATERPROOF PART
9: SECOND WATERPROOF PART
R1: FIRST RESIN
R2: SECOND RESIN
UV: ULTRAVIOLET RAY

What is claimed is:

1. A switch comprising:
a case which is formed of a first resin and has a recess;
a plurality of fixed conductive members supported by the case;
a movable conductive member configured to be capable of changing a state of electrical connection between the plurality of fixed conductive members;
a cover, wherein the recess is sealed with the cover; and
a waterproof part formed of a second resin whose adhesion to the plurality of fixed conductive members is higher than an adhesion of the first resin to the plurality of fixed conductive members,
wherein each of the plurality of fixed conductive members includes a first portion arranged inside the recess, a second portion exposed to an outside of the case, and a third portion positioned between the first portion and the second portion, and
wherein the waterproof part surrounds the third portion of the each of the plurality of fixed conductive members.

2. The switch according to claim 1, wherein the second resin is an ultraviolet curable resin.

3. The switch according to claim 2, wherein the cover abuts on the waterproof part.

4. A manufacturing method of a switch, the manufacturing method comprising:
supporting a plurality of fixed conductive members by a case made of a first resin so that a first portion of each of the plurality of fixed conductive members is arranged inside a recess of the case, a second portion of the each of the plurality of fixed conductive member is exposed to an outside of the case, and a third portion of the each of the plurality of fixed conductive member is exposed to an inside of a hole of the case;
arranging a movable conductive member in the recess of the case, wherein the movable conductive member is configured to be capable of changing a state of electrical connection between the plural fixed conductive members;
sealing the recess with a cover;
filling the hole of the case with a second resin whose adhesion to the plurality of fixed conductive members is higher than an adhesion of the first resin to the plurality of fixed conductive members; and
curing the second resin and forming a waterproof part that surrounds the third portion of the each of the plurality of fixed conductive members.

5. The manufacturing method of switch according to claim 4, wherein the hole is a through hole penetrating through the case, and
wherein, in a condition that one end of the hole covered with the cover, the hole is filled with the second resin from the other end of the hole.

6. The manufacturing method of switch according to claim 4, wherein the second resin is cured by irradiation with ultraviolet rays.
